(19) United States
(12) Patent Application Publication
(10) Pub. No.: US 2007/0118448 A1
(43) Pub. Date: May 24, 2007

(54) MY CORPORATE LOTTO

(75) Inventor: Jeffery D Thompson, Fort Worth, TX (US)

Correspondence Address: Jeffery Thompson, 6100 Oakland Hills Dr # 301, Fort Worth, TX, 76112, US

(73) Assignee: SYSTEM'S PRIDE, Fort Worth, TX (US)

(21) Appl. No.: 11/164,420

(22) Filed: Nov. 22, 2005

(51) Int. Cl. G06Q 40/00

(52) U.S. Cl. 705/35

(57) ABSTRACT

My Corporate Lotto (MCL) was developed primarily as a lottery game management computer application, designed to maintain, and distribute funds, to members of a syndicate known as shareholders. With MCL, winnings are distributed proportionally to how much each shareholder has invested in the syndicate or group, known as the Corporation. The application may also be used where a monetary, award, banking, or profit sharing program is implemented, where distribution of awards are shared among members of the group based on their level of interest or investment in the corporation.

### CROSS-REFERENCE TO RELATED APPLICATIONS

Not applicable.

### REFERENCE TO A COMPUTER PROGRAM LISTING COMPACT DISC APPENDIX

Computer program listing compact disc appendix submitted in this filing. See document titled: Appendix Index.

### BACKGROUND OF THE INVENTION

My Corporate Lotto (MCL) was developed to group and organize a group or groups of lottery gamers, and to provide a managerial structure to the groups.

### BRIEF SUMMARY OF THE INVENTION

Many people today play games of chance, such as the state sponsored lotteries purely on chance without any structure of method, or structure of organization. Not every individual has the dedicated resouces to play on a weekly basis, and playing lotteries with this ad hoc methodology produces the odd of a major win in numbers resulting in millions and sometimes billions to one.

MCL organizes and combine resources of people playing the lotteries or games of chance, into a corporate styled group, and provides a method of improving odds, provides a method of tracking, and provides a method of outlining an organizational structure by level of interest in the corporate group. Corporate member may participate in gaming when most convenient because of this maintained level of interest.

A corporate member, known as a shareholder, submit assets into a pool of funds, known as “available assets”, the shareholder's standing is determined in proportion to the total available assets. The shareholder's standing is a key feature of the application, as the distribution of winnings or awards are based on this value, in addition, if the shareholder decide to no longer participate in the corporate gaming, the “Cashout” option is based on the shareholder's standing.

Definition List 1

| Term | Definition |
|---|---|
| Assets | Any funds added by a shareholder, to be |
| | uses in lottery gaming and/or increase |
| | corporate standing. |
| Available funds | Current assets available for use in lottery |
| | gaming, or Cashout. Funds are added to |
| | Available funds when shareholders add |
| | assets. Funds are drawn when games are |
| | added to the database or upon |
| | completion of a Cashout. |
| Cashout | The voluntary withdrawal from all-future |
| | benefits and awards received by the |
| | Corporation. Cashout is voluntary and |
| | cannot be reversed. The award of the |
| | Cashout is the “Cashout Payout”. |
| Cashout Payout | Result of a Cashout, calculated by |
| | multiplying a shareholder's standing by |
| | available funds. |
| Corporate Standing | See “Standing”. |
| Distribution | Corporate decision to disburse the |
| | results of an award to shareholders |
| | according to the shareholder's corporate |
| | standing. |
| My Corporate Lotto | My Corporate Lotto is a User-friendly |
| | State lottery database management tool. |
| | Tailored as a generic tool, developed |
| | with the idea of managing a Lottery |
| | playing group with a corporate |
| | organizational style of management. |
| Shareholder | A person who buys shares in a |
| | corporation styled group, and therefore |
| | becomes a part owner of the |
| | corporation. |
| Standing | Shareholder's ranking within the My |
| | Corporate Lotto database, derived by |
| | dividing the sum of assets added by the |
| | shareholder by the total of asset added |
| | by all shareholders. |

### BRIEF DESCRIPTION OF THE VIEWS OF THE DRAWINGS

FIG. 1 shows the flow of currency of the MCL model.

FIG. 1 shows the entity relationship of the MCL database.

### DETAILED DESCRIPTION OF THE INVENTION

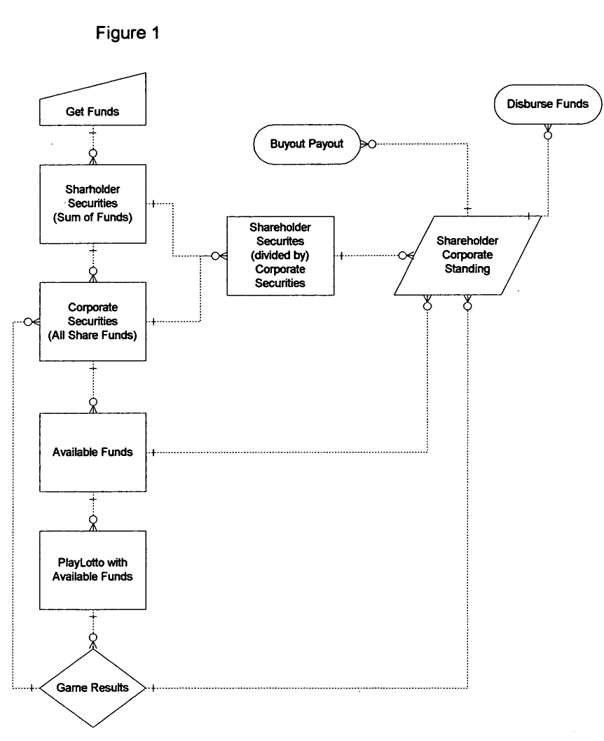

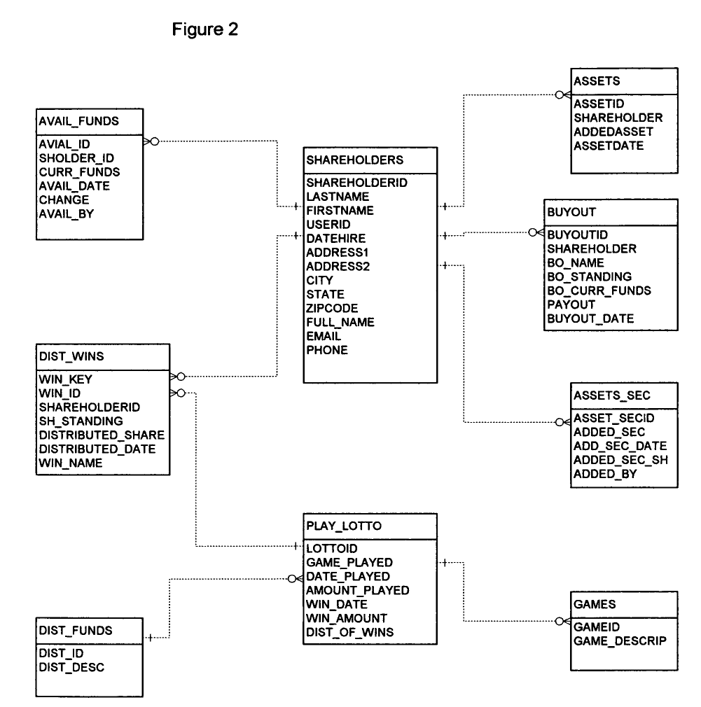

As shown in FIG. 1, assets are received from the shareholders. Theses assets are compiled into two aspects of the application; the sum of the assets added by a shareholder is the total shareholder securities, and the combined sum of the shareholder's securities make up the corporate securities. After dividing a shareholder's securities by corporate securities, the result is the shareholder's standings.

Funds added to the database become “Available funds”; the funds to play lottery games are subtracted from the available funds. In the event an award is received from a lottery game, a corporate decision is made to distribute the award to shareholders with respect to the shareholder's standings, or a rollover of funds will add the funds to the “Available funds”.

A Cashout is the product result of the shareholder's standings and the current available funds. Once the Cashout is completed, the shareholder is removed from the database.

FIG. 2 outlines the entity-relationship of the My Corporate Lotto database. As assets are saved in the “Assets” table, the new asset value is also added to the tables “Available_Funds” and “Assets_Sec”. In the Assets_Sec table, assets are never deleted, and used with the shareholder total assets to calculate the shareholder's standing. Assets are drawn from the Available_Funds table when a lottery play is made, or when a Cashout is made.

The Play_Lotto table maintains records of the games played. The amount for a play is drawn from the Available_Funds table, the game selection type is made from the Games table, and the decision of the distribution of funds is selected from the Dist_Funds table. The Games table contains a list of games the group participates. The Dist_Funds table contains a list of decisions applied to an award from a lottery play.

After a lottery result is obtained a decision is made on the Dist_Funds table. When the decision is equal to zero (0), the only decision option is “Award None”. When the decision is greater than zero (0), the decision options are “Rollover” or “Distribute”. A Rollover decision will add the award to the Avail_Funds table; a Distribute decision will insert a row in the “Dist_Win” table for each shareholder base on the product of the award multiplied by the shareholder's corporate standing.

Addition of a new shareholder will insert a new row in the “Shareholder” table. A delete on the shareholder table can only be performed if the shareholder does not have a corporate standing. If the shareholder does have a corporate standing, a Cashout must be performed on the row. Performing a Cashout will insert a new row in the “Buyout” table. The Cashout is the product of the current assets of the Available_Funds and the shareholder's standing.

Typical Scenario
Three Shareholders: Bob, Sarah, Tim

Getting Assets:

Three Shareholders: Bob, Sarah, Tim
Getting Assets:

| Bob | Sarah | Tim | |
|---|---|---|---|
| $20 | $30 | $25 | Week 1 |
| $10 | $20 | $40 | Week 2 |
| $15 | $20 | $40 | Week 3 |
| $45 | $70 | $105 = | $220.00 |

| | |
|---|---|
| Shareholder's Securities | Corporate Securities |

| | | |
|---|---|---|
| .205 | .318 | .477 |

Shareholder's Corporate Standings

Available Funds = $220.00
Play_Lotto Game # 1: $80.00; Scratchers --> Available Funds reduced to = $140.00
Play_Lotto Game # 2: $60.00; Mega Millions --> Available Funds reduced to = $80.00
Game # 1 results: Winnings = $200.00
Corporate decision: ROLLOVER! ----> Winning are added to Available funds;
Available funds = $280.00
Game # 2 results: Winnings = $1000.00
Corporate decision: DISTRIBUTE! ----> Winning are disburse to Shareholders

| | | | |
|---|---|---|---|
| Bob | Sarah | Tim | |
| 1000 | 1000 | 1000 | |
| .205 | .318 | .477 | multiply by Standings |
| $205.00 | $318.00 | $477.00 | Distributed Shares; Totaling |
| | | | $1000.00 |

Bob has decided to Cashout!

| | |
|---|---|
| $280 | Available Funds |
| .205 | Shareholder Standing |
| $57.40 | Cashout payout --> Available Funds now $222.60 |

Everyone say goodbye to Bob, “See ya later Bob”.

Available Funds=$220.00
Play_Lotto Game #1: $80.00; Scratchers→Available Funds reduced to=$140.00
Play_Lotto Game #2: $60.00; Mega Millions→Available Funds reduced to=$80.00
Game #1 results: Winnings=$200.00
Corporate decision: ROLLOVER!→Winning are added to Available funds;
Available funds=$280.00

Everyone say goodbye to Bob, “See ya later Bob”.

What is claimed is:

1. An organizational lottery gaming financial management system consisting of: Tracking of members assets, input for a shared organizational consideration, and distributions of awards in relation to personal level of investment in the organization.

2. The method of claim 1, wherein the mode of transaction comprise: a computer, a web site, the internet, a player device, electronic mail, interactive voice, or point of sale terminal.

3. The method of claim 1, wherein an asset shall be considered as any item of value.
